(19) United States
(12) Patent Application Publication
(10) Pub. No.: US 2013/0103382 A1
(43) Pub. Date: Apr. 25, 2013

(54) METHOD AND APPARATUS FOR SEARCHING SIMILAR SENTENCES

(71) Applicants: Jeong Se Kim, Daejeon (KR); Sanghun Kim, Daejeon (KR); Soo-jong Lee, Daejeon (KR); Ji Hyun Wang, Daejeon (KR); Seung Yun, Daejeon (KR)

(72) Inventors: Jeong Se Kim, Daejeon (KR); Sanghun Kim, Daejeon (KR); Soo-jong Lee, Daejeon (KR); Ji Hyun Wang, Daejeon (KR); Seung Yun, Daejeon (KR)

(73) Assignee: Electronics and Telecommunications Research Institute, Daejeon (KR)

(21) Appl. No.: 13/598,017

(22) Filed: Aug. 29, 2012

(30) Foreign Application Priority Data
Oct. 19, 2011 (KR) 10-2011-0106952

(51) Int. Cl. G06F 17/28

(52) U.S. Cl. 704/2

(57) ABSTRACT

An apparatus for searching similar sentences that has a translation sentence database includes an input unit to which a sentence is input; first language processing unit configured to perform language processing on sentences input through the input unit; and first language similarity calculating unit configured to refer to previously translated sentences to extract similar sentences for the first language sentence. Further, the apparatus includes translating unit configured to translate a sentence into a second language sentence; second language processing unit configured to perform language processing on a second language sentence; second language similarity calculating unit configured to refer to the previously translated sentences to extract similar sentences for the second language sentence; and a re-ranking unit configured to combine similar sentence extracting results of the first language with those of the second language to re-rank sentence outputs.

### CROSS-REFERENCE TO RELATED APPLICATION(S)

The present invention claims priority of Korean Patent Application No. 10-2011-0106952, filed on Oct. 19, 2011, which is incorporated herein by reference.

### FIELD OF THE INVENTION

The present invention relates to a technology of searching similar sentences; and more particularly, to an apparatus and a method for searching similar sentences, which are appropriate to enhance performance of searching similar sentences by re-ranking sentences searched at the time of measuring similarity between the sentences to provide intended sentences more similar to input sentences.

### BACKGROUND OF THE INVENTION

A general apparatus for searching similar sentence includes an input unit, a similarity calculating unit, an output unit, and the like and may generate identical sentence similarity possibility values that are calculated by the similarity calculating unit.

When the similarity calculation results completely coincide with the input sentences, a rank of the sentences is adjusted to a first rank, but when the similarity calculation results do not completely coincide with the input sentences, there is a problem on which of the sentences having the same possibility values is determined as a high rank.

For solving the above problem, a scheme for re-ranking similar sentences searched using various probability values is proposed, but a scheme for re-ranking translated second languages has not yet been proposed.

The above-mentioned technical configuration is a background art for helping understanding of the present invention and does not mean related arts well known in a technical field to which the present invention pertains.

### SUMMARY OF THE INVENTION

In view of the above, the present invention provides a method and an apparatus for searching similar sentences, which are capable of improving performance of searching similar sentences by re-ranking sentences searched at the time of measuring similarity between sentences to provide optimal sentences more similar to input sentences.

In accordance with a first aspect of the present invention, there is provided an apparatus for searching similar sentences having a translation sentence database in which previously translated sentences having a pair of first language and second language are stored. The apparatus for searching similar sentences includes an input unit to which a sentence is input; a first language processing unit configured to perform language processing on sentences input through the input unit with a first language sentence; a first language similarity calculating unit configured to refer to the previously translated sentences of the translation sentence database to extract similar sentences for the first language sentence; a translating unit configured to translate any sentence into the second language sentence; a second language processing unit configured to perform language processing on the second language sentence translated by the translating unit; a second language similarity calculating unit configured to refer to the previously translated sentences of the translation sentence database to extract similar sentences for the second language sentence; and a re-ranking unit configured to combine similar sentence extracting results of the first language with those of the second language to re-rank sentence outputs.

In accordance with a second aspect of the present invention, there is provided a method for searching similar sentences. The method for searching the similar sentences includes processing, by a first language processing unit, language processing on a sentence input through an input unit using a first language sentence; comparing, by a first language similarity calculating unit, the language-processed first language sentence with previously stored translation sentences to calculate sentence similarity; translating the sentence with a second language by a translating unit; processing language processing on the translated second language with a second language sentence by a second language processing unit; comparing, by a second language similarity calculating unit, the language-processed second language sentence with the previously stored translation sentences to calculate sentence similarity; and combining sentence similarity calculating results for each of the first language sentence with the second language sentence to re-rank final translation sentence outputs by a re-ranking unit.

In accordance with the embodiments of the present invention, it is possible to improve the performance of searching similar sentence by searching the previously translated sentences including the user's intention by using the technologies such as sentence similarity measurement, text frame similarity measurement, and the like, for voice recognition results. Therefore, it is possible to improve the interpretation performance of the automatic translator without using the complicated algorithm of the automatic translator or many resources for translation.

### BRIEF DESCRIPTION OF THE DRAWINGS

The objects and features of the present invention will become apparent from the following description of embodiments given in conjunction with the accompanying drawings, in which:

FIG. 1 is a schematic configuration block diagram of an apparatus for searching similar sentences in accordance with an embodiment of the present invention; and

FIG. 2 is a flow chart for exemplarily describing a method for searching similar sentences in accordance with the embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram. Hereinafter, embodiments of the present invention will be described in detail with reference to the accompanying drawings which form a part hereof.

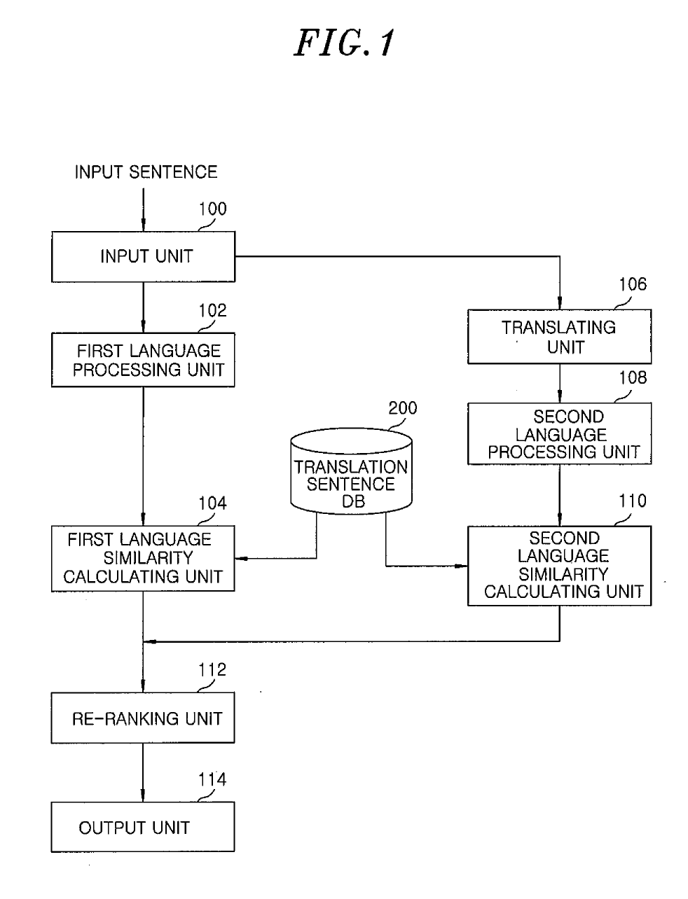

FIG. 1 is a schematic configuration block diagram of an apparatus for searching similar sentences in accordance with an embodiment of the present invention. The apparatus for searching similar sentences may include an input unit 100, a first language processing unit 102, a first language similarity calculating unit 104, a translating unit 106, a second language processing unit 108, a second language similarity calculating unit 110, a re-ranking unit 112, an output unit 114, a translation sentence database (DB) 200, and the like.

As shown in FIG. 1, the input unit 100 may receive sentences from a user. In this case, the sentence input may be implemented by, e.g., a voice recognition unit, a key input unit, and the like, but the sentences need not to be input by specific units. However, in the case of the voice recognition unit, a technology of recognizing the user's voice and then, translating the recognized user's voice into sentences may be provided and in the case of the key input unit, various types of key input units may be applied through a keypad.

The first language processing unit 102 may extract elements required to allow the first language similarity calculating unit 104 to be described below to calculate the similarity by performing language processing on sentences input through the input unit 100 using a first language sentence, e.g., performing language processing on Korean sentence. Elements required to calculate the similarity may include, for example, at least one of word, clause, morpheme and part of speech, sentence pattern, tense, affirmation and negation, modality information, speech act information representing a flow of conservation, and the like.

In addition, the first language processing unit 102 may apply high-rank semantic information (class information), such as name, place name, amount, date, number, and the like.

In addition, the first language processing unit 102 may search similar representations through similar word extension and allomorph extension. Similar words mean other words having similar meaning like, e.g., “losing-robbing” and the allomorph means foreign words such as “sheet-seat” or words having a different form but having the same meaning, like “break-crush”.

The first language similarity calculating unit 104 may extract similar sentences for the first language among the previously translated sentences within the translation sentence DB 200 configured in a pair of the first language and the second language. Specifically, the first language similarity calculating unit 104 may determine similarity between keywords of the translation sentence DB 200 for the first language sentence that are results language-processed by the first language processing unit 102 and keywords for each candidate sentence of corpus to be searched to extract optimal similar sentences.

The translating unit 106 may translate sentences input through the input unit 100. For example, the translating unit 106 may translate Korean sentences into English sentences.

The second language processing unit 108 may perform the language processing on the second language, e.g., English sentences translated by the translating unit 106 to extract elements required to allow the second language similarity calculating unit 110 to be described below to calculate similarity. Elements required to calculate the similarity may include, e.g., at least one of word, morpheme and part of speech, sentence pattern, tense, affirmation and negation, modality information, speech act information, and the like.

Further, the second language processing unit 108 may serve to apply the high-rank semantic information (class information) to name, place name, amount, date, number, and the like and to search similar representations through the similar word extension and the allomorph extension.

The second language similarity calculating unit 110 may extract similar sentences for the second language among the previously translated sentences within the translation sentence DB 200 configured in a pair of the first language and the second language. In detail, the second language similarity calculating unit 110 may determine similarity between keywords of the translation sentence DB 200 for the input sentences that are results language-processed by the second language processing unit 108 and keywords for each candidate sentence of corpus to be searched to extract optimal similar sentences.

The re-ranking unit 112 may combine the similar sentence extracting results (similarity calculation results) of the first language and the similar sentence extracting results (similarity calculation results) of the second language to re-rank the sentence outputs.

The result values re-ranked by the re-ranking unit 112 may be represented by the following Equation 1.

Re-ranked result value=Similarity calculation result of first language similarity calculating unit 104×A+Similarity calculation result of second language similarity calculating unit 110×B [Equation 1]

Here, a sum of A and B is equal to 1.

The output unit 114 may receive the result values re-ranked by the re-ranking unit 112 to output the re-ranked translation sentences to the outside. In this case, as the external output, e.g., a screen output through a display device, and the like, may be applied.

The translation sentence DB 200 may store a plurality of previously translated sentences and may refer to the sentences previously translated by the first language similarity calculating unit 104 or the second language similarity calculating unit 110.

As described above, the translation sentence DB 200 may be configured to meet the objects of the present invention by using a relational database management system (RDBMS) such as Oracle, Informix, Sybase, DB2, and the like, or an object-oriented database management system (OODBMS) such as Gemston, Orion, O2, and the like, and may have appropriate fields to achieve its own function.

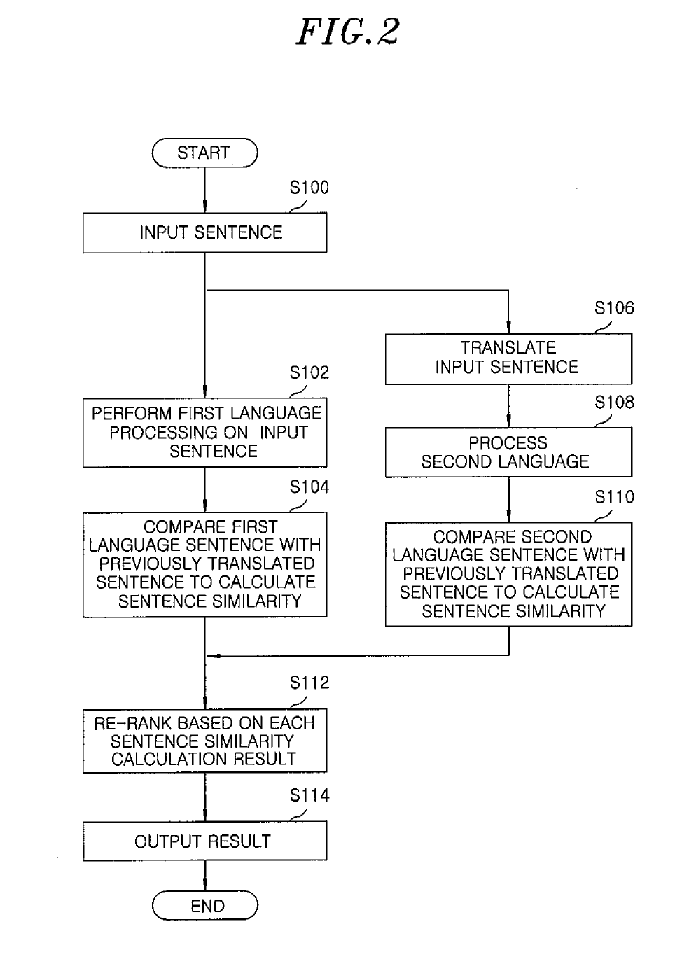

Hereinafter, together with the foregoing configuration, the method for searching similar sentences in accordance with the embodiment of the present invention will be described in detail with reference to a flow chart of the accompanying FIG. 2.

As shown in FIG. 2, when a sentence is input through the input unit 100 in step S100, the first language processing unit 102 may perform the language processing on the sentence input through the input unit 100 with the first language sentence, e.g., the language processing on Korean sentences to extract elements required to allow the first language similarity calculating unit 104 to calculate the similarity in step S102. In this case, the elements required to calculate the similarity may include, e.g., at least one of word, clause, morpheme and part of speech, sentence pattern, tense, affirmation and negation, modality information, speech act information representing a flow of conservation, and the like.

Next, in step S104, the first language similarity calculating unit 104 may compare the first language sentence that is language-processed by the first language processing unit 102 with the translation sentences previously stored in the translation sentence DB 200 to calculate the sentence similarity, thereby extracting the similar sentences for the first language sentence.

Further, the translating unit 106 may translate a sentence input through the input unit 100 in step S106. For example, it is possible to translate Korean sentences into the English sentences.

Subsequently, in step S108, the second language processing unit 108 may perform the language processing on the second language translated by the translating unit 106, e.g., English sentences to extract the elements required to allow the second language similarity calculating unit 110 to calculate the similarity. The elements required to calculate the similarity may include, e.g., at least one of word, morpheme and part of speech, sentence pattern, tense, affirmation and negation, modality information, speech act information, and the like.

In step S110, the second language similarity calculating unit 110 may compare the second language sentence that is language-processed by the second language processing unit 108 with the translation sentences previously stored in the translation sentence DB 200 to calculate the sentence similarity, thereby extracting the similar sentences for the second language sentence.

As described above, when the similar sentences for the first language sentence and the second language sentence are extracted (when each similarity is calculated), in step S112, the re-ranking unit 112 may combine the similar sentence extracting results (similarity calculating results) of the first language sentence with the similar sentence extracting results (similarity calculating results) of the second language sentence to re-rank the final translation sentence outputs.

Finally, in step S114, the final sentences may be output to the outside according to the outputs re-ranked by the re-ranking unit 112.

Further, the method for searching similar sentences in accordance with various embodiments of the present invention can be implemented as codes stored in a computer-readable storage medium, which can be executed by a computer, wherein the computer-readable storage medium may include all the types of storage device in which data readable by the computer system are stored. As an example of the computer-readable storage medium, there are an ROM, an RAM, an optical recording medium, and the like, and codes or programs executable with a computer may also be distributed and executed in the computer system connected to the network so distributedly perform the functions of the present invention.

As described above, in accordance with the embodiments of the present invention, it is possible to provide the optimal sentences more similar to the input sentences by re-ranking the sentences searched at the time of measuring similarity between sentences and improve the performance of searching sentence by searching the previously translated sentences including the user's intention by using the technologies such as sentence similarity measurement, textframe similarity measurement, and the like, for the voice recognition results. Therefore, it is possible to improve the interpretation performance of the automatic translator without using the complicated algorithm of the automatic translator or many resources for translation.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for searching similar sentences having a translation sentence database in which previously translated sentences having a pair of first language and second language are stored, the apparatus comprising:
an input unit to which a sentence is input;
a first language processing unit configured to perform language processing on sentences input through the input unit with a first language sentence;
a first language similarity calculating unit configured to refer to the previously translated sentences of the translation sentence database to extract similar sentences for the first language sentence;
a translating unit configured to translate any sentence into the second language sentence;
a second language processing unit configured to perform language processing on the second language sentence translated by the translating unit;
a second language similarity calculating unit configured to refer to the previously translated sentences of the translation sentence database to extract similar sentences for the second language sentence; and
a re-ranking unit configured to combine similar sentence extracting results of the first language with those of the second language to re-rank sentence outputs.

2. The apparatus of claim 1, wherein the re-ranking unit combines similarity calculating results of the first language with similarity calculating results of the second language to re-rank the sentence outputs.

3. The apparatus of claim 1, wherein the first language processing unit extracts elements required to allow the first language similarity calculating unit to calculate similarity.

4. The apparatus of claim 3, wherein the elements required to calculate the similarity include at least one of word, clause, morpheme and part of speech, sentence pattern, tense, affirmation and negation, modality information, and speech act information.

5. The apparatus of claim 1, wherein the second language processing unit extracts the elements required to allow the second language similarity calculating unit to calculate the similarity.

6. The apparatus of claim 5, wherein elements required to calculate the similarity include at least one of word, morpheme and part of speech, sentence pattern, tense, affirmation and negation, modality information, and speech act information.

7. The apparatus of claim 1, wherein the input unit inputs a sentence by a voice recognition unit or a key input unit.

8. The apparatus of claim 1, further comprising an output unit configured to output the re-ranked translation sentences to the outside by receiving result values re-ranked by the re-ranking unit.

9. A method for searching similar sentences, comprising:
processing, by a first language processing unit, language processing on a sentence input through an input unit using a first language sentence;
comparing, by a first language similarity calculating unit, the language-processed first language sentence with previously stored translation sentences to calculate sentence similarity;
translating the sentence with a second language by a translating unit;
processing language processing on the translated second language with a second language sentence by a second language processing unit;
comparing, by a second language similarity calculating unit, the language-processed second language sentence with the previously stored translation sentences to calculate sentence similarity; and
combining sentence similarity calculating results for each of the first language sentence with the second language sentence to re-rank final translation sentence outputs by a re-ranking unit.

10. The method of claim 9, wherein said performing language processing on a sentence includes extracting elements required to allow the first language similarity calculating unit to calculate similarity.

11. The method of claim 10, wherein the elements required to allow the first language similarity calculating unit to calculate the similarity include at least one of word, clause, morpheme and part of speech, sentence pattern, tense, affirmation and negation, modality information, and speech act information.

12. The method of claim 9, wherein said performing language processing on the translated second language includes extracting elements required to allow the second language similarity calculating unit to calculate similarity.

13. The method of claim 12, wherein the elements required to allow the second language similarity calculating unit to calculate the similarity include at least one of word, morpheme and part of speech, sentence pattern, tense, affirmation and negation, modality information, and speech act information.

14. The method of claim 9, further comprising outputting the re-ranked translation sentences to the outside by receiving result values re-ranked by the re-ranking unit.
